(19) United States
(12) Patent Application Publication
(10) Pub. No.: US 2026/0172138 A1
(43) Pub. Date: Jun. 18, 2026

(54) CODE BLOCK SIZE REPORTING DESIGN

(71) Applicant: QUALCOMM Incorporated, San Diego, CA (US)

(72) Inventors: Wei YANG, San Diego, CA (US); Jing JIANG, San Diego, CA (US); Jing SUN, San Diego, CA (US); Thomas Joseph RICHARDSON, South Orange, NJ (US); Gabi SARKIS, San Diego, CA (US)

(21) Appl. No.: 18/979,277

(22) Filed: Dec. 12, 2024

(51) Int. Cl. H04L 1/00

(52) U.S. Cl. CPC H04L 1/0041; H04L 1/0006; H04L 1/0057

(57) ABSTRACT

Methods, systems, and devices for wireless communications are described. A user equipment (UE) may transmit a UE capability message that identifies a maximum code block size supported by the UE, wherein the maximum code block size corresponds to a low-density parity-check (LDPC) coding process of the UE. The UE may perform wireless communications comprising one or more code blocks, wherein a code block size of each code block in the one or more code blocks is based at least in part on the maximum code block size supported by the UE.

### FIELD OF TECHNOLOGY

The following relates to wireless communications, including code block size reporting design.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a UE capability message that identifies a maximum code block size supported by the UE, where the maximum code block size corresponds to a low-density parity-check (LDPC) coding process of the UE and performing wireless communications including one or more code blocks, where a code block size of each code block in the one or more code blocks is based on the maximum code block size supported by the UE.

A UE for wireless communications is described. The UE may include one or more memories storing processor executable code, and one or more processors coupled with the one or more memories. The one or more processors may individually or collectively be operable to execute the code to cause the UE to transmit a UE capability message that identifies a maximum code block size supported by the UE, where the maximum code block size corresponds to a LDPC coding process of the UE and perform wireless communications including one or more code blocks, where a code block size of each code block in the one or more code blocks is based on the maximum code block size supported by the UE.

Another UE for wireless communications is described. The UE may include means for transmitting a UE capability message that identifies a maximum code block size supported by the UE, where the maximum code block size corresponds to a LDPC coding process of the UE and means for performing wireless communications including one or more code blocks, where a code block size of each code block in the one or more code blocks is based on the maximum code block size supported by the UE.

A non-transitory computer-readable medium storing code for wireless communications is described. The code may include instructions executable by one or more processors to transmit a UE capability message that identifies a maximum code block size supported by the UE, where the maximum code block size corresponds to a LDPC coding process of the UE and perform wireless communications including one or more code blocks, where a code block size of each code block in the one or more code blocks is based on the maximum code block size supported by the UE.

In some examples of the method, user equipment (UEs), and non-transitory computer-readable medium described herein, the UE capability message indicates the maximum code block size supported by the UE as at least one of a maximum quantity of bits supported in a code block or a maximum lifting size supported for the LDPC coding process.

In some examples of the method, user equipment (UEs), and non-transitory computer-readable medium described herein, the maximum lifting size may be associated with a cyclic lifting process of the LDPC coding process.

In some examples of the method, user equipment (UEs), and non-transitory computer-readable medium described herein, the maximum code block size identified in the UE capability message includes at least one of a maximum uplink code block size, a maximum downlink code block size, and a maximum sidelink code block size.

Some examples of the method, user equipment (UEs), and non-transitory computer-readable medium described herein may further include operations, features, means, or instructions for performing additional wireless communications in accordance with a reference code block size, where the reference code block size satisfies at least the maximum code block size supported by the UE.

Some examples of the method, user equipment (UEs), and non-transitory computer-readable medium described herein may further include operations, features, means, or instructions for selecting, for the wireless communications, the maximum code block size or a reference code block size as the code block size used for each code block in the one or more code blocks.

In some examples of the method, user equipment (UEs), and non-transitory computer-readable medium described herein, the selecting may be in accordance with at least one of a format of a downlink control information (DCI) grant scheduling the wireless communications, a radio network temporary identifier (RNTI) associated with the DCI grant, a modulation and coding scheme (MCS) table associated with the DCI grant, and a scheduling mode associated with the wireless communications.

Some examples of the method, user equipment (UEs), and non-transitory computer-readable medium described herein may further include operations, features, means, or instructions for receiving a configuration associated with a network-configured maximum code block size to be used for the wireless communications, where the network-configured maximum code block size may be equal to or less than the maximum code block size identified in the UE capability message.

In some examples of the method, user equipment (UEs), and non-transitory computer-readable medium described herein, the maximum code block size may be restricted to a reference code block size in accordance with a channel type associated with the wireless communications.

Some examples of the method, user equipment (UEs), and non-transitory computer-readable medium described herein may further include operations, features, means, or instructions for selecting the code block size for the one or more code blocks according to a probabilistic shaping operation performed on the one or more code blocks based on the maximum code block size or a reference code block size.

Some examples of the method, user equipment (UEs), and non-transitory computer-readable medium described herein may further include operations, features, means, or instructions for determining one or more channel quality metrics for reporting in accordance with at least one of the maximum code block size or a reference code block size.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports code block size reporting design in accordance with one or more aspects of the present disclosure.

FIG. 2 shows an example of a wireless communications system that supports code block size reporting design in accordance with one or more aspects of the present disclosure.

FIG. 3 shows an example of a method that supports code block size reporting design in accordance with one or more aspects of the present disclosure.

FIG. 4 shows an example of a method that supports code block size reporting design in accordance with one or more aspects of the present disclosure.

FIGS. 5 and 6 show block diagrams of devices that support code block size reporting design in accordance with one or more aspects of the present disclosure.

FIG. 7 shows a block diagram of a communications manager that supports code block size reporting design in accordance with one or more aspects of the present disclosure.

FIG. 8 shows a diagram of a system including a device that supports code block size reporting design in accordance with one or more aspects of the present disclosure.

FIGS. 9 through 11 show flowcharts illustrating methods that support code block size reporting design in accordance with one or more aspects of the present disclosure.

### DETAILED DESCRIPTION

Wireless networks may support various infrastructure designs to support different networks. For example, some wireless networks may use separate radio access technology (RAT) networks to support different ecosystems. However, future networks may attempt to support such different ecosystems (e.g., internet-of-thing (IoT), enhanced machine-type communications (eMTC), enhanced reduced capability (eRedCaP) devices, and others) using a common or unified air interface design. This may present issues with respect to low-density parity-check (LDPC) coding operations. For example, the LPDC decoder chip area (e.g., memory and other decoding logical functionality) may vary greatly between different device types. For example, some wireless devices may communicate small data (e.g., sensors) while other device types may communicate inordinately large amounts of data. In some networks, the LDPC chip area of each device type may be the same to ensure compatibility. However, this approach may reduce efficiency and present scaling issues for such advanced networks.

Accordingly, aspects of the techniques described herein may provide for improved coding designs to enable co-designs between different device types. In some aspects, this may be based on a user equipment (UE) reporting its maximum code block size or the maximum lifting value (e.g., for LDPC coding) to the network. For example, the UE may transmit or otherwise convey a UE capability message to a network entity. the UE capability message may identify a maximum code block size supported by the UE. In some aspects, the maximum code block size may correspond to a LDPC coding process of the UE. The UE may perform wireless communications that includes transmitting or receiving one or more code blocks. In some aspects, a code block size of each code block in the one or more code blocks is in accordance with the maximum code block size supported by the UE.

Aspects of the disclosure are initially described in the context of wireless communications systems. Aspects of the disclosure are further illustrated by and described with reference to apparatus diagrams, system diagrams, and flowcharts that relate to code block size reporting design.

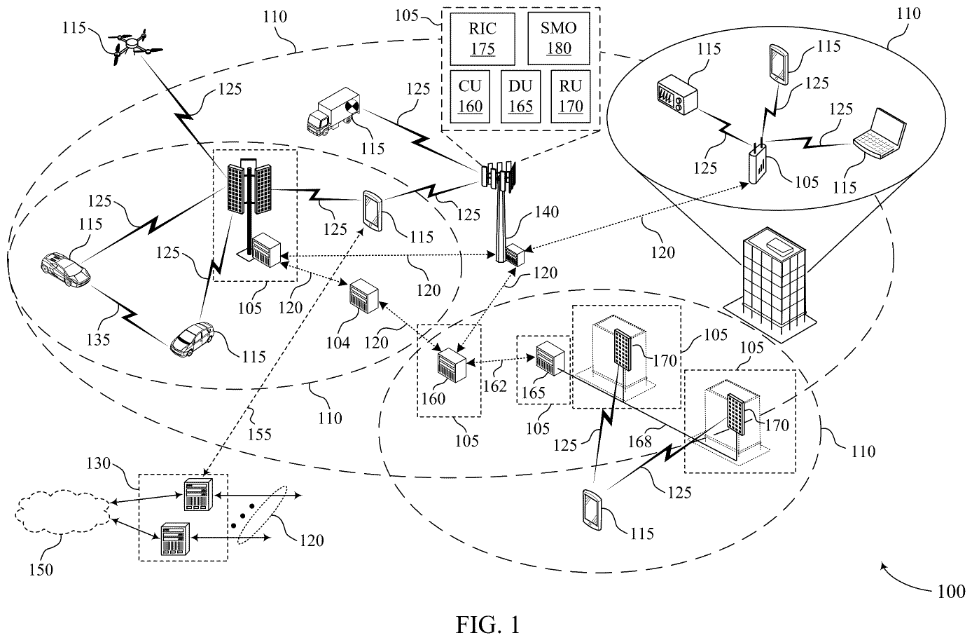

FIG. 1 shows an example of a wireless communications system 100 that supports code block size reporting design in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support code block size reporting design as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit (and a network entity 105 may receive) a UE capability message that identifies a maximum code block size supported by the UE, wherein the maximum code block size corresponds to a LDPC coding process of the UE 115. The UE 115 and the network entity 105 (or a different UE 115 for sidelink communications) may perform wireless communications comprising one or more code blocks, wherein a code block size of each code block in the one or more code blocks is based at least in part on the maximum code block size supported by the UE 115.

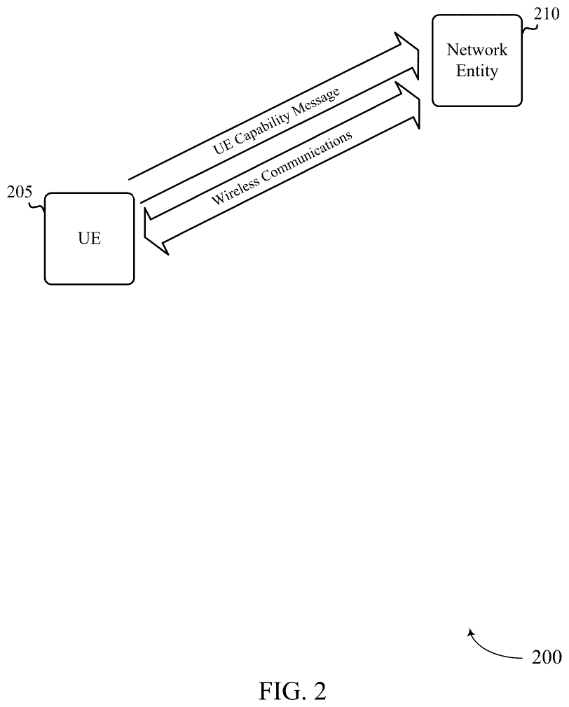

FIG. 2 shows an example of a wireless communications system 200 that supports code block size reporting design in accordance with one or more aspects of the present disclosure. Aspects of the wireless communications system 200 may implement aspects of or be implemented by aspects of the wireless communications system 100. Aspects of the wireless communications system 200 may be implemented at or implemented by a UE 205 and a network entity 210, which may be examples of the corresponding devices described herein. The techniques described herein are generally illustrates as cellular (e.g., Uu interface) communication examples between the UE 205 and the network entity 210. However, it is to be understood that the described techniques may be implemented for sidelink (e.g., PC5 interface) communications between the UE 205 and another UE.

Some wireless networks may support multiple, separate networks to support different communication types. This may include multiple RATs being deployed to support the different communication types. For example, the multiple, separate networks may include an eMBB network, an eMTC network, a NB-IoT network, and an (e)RedCap network, with each network supporting its own configuration and management. This approach, however, may lead to separate IoT networks (e.g., RATs) being deployed which leads to high deployment and operating costs. Moreover, this approach may not address the very long life cycle of IoT devices. Some networks may support a common RAN for eMBB and IoT devices to minimize the cost overhead (e.g., for IoT support). This common network may share common designs between the IoT and the eMBB device communications. For example, this may facilitate the IoT ecosystem scaling and enable multiple device type multiplexing. This may support a scaled down eMBB network with area efficient and low power design. That is, this network may make sure the coverage enhancement and lower UE power features are also generic features for eMBB devices to enable advanced network (e.g., sixth generation (6G) and beyond) coverage native design. Moreover, this may provide deep coverage and low power feature deployment to facilitate a lower tier IoT ecosystem scaling in later deployments.

However, some wireless networks (e.g., advanced networks) may transition from multiple RATs to a single RAT that supports different devices categories (e.g., eMBB, IoT 10 MHz, IoT 5 MHz, and others). For example, the single RAT or RAN network may provide an ecosystem that supports an IoT and eMBB unified air interface. However, this may create an issue with respect to how to design the channel coding to scale across different data rates or device complexity.

One such issue may relate to the quasi-cyclic (QC) LDPC coding process. LDPC encoding is generally applied by a transmitting device communicating messages to a receiving device over a noisy channel. The receiving device may apply LDPC decoding operations to recover the information conveyed in the messages. The QC-LDPC coding process may include the code being described by a base graph and liftings, which may also be referred to as a photograph LDPC code. The code in this context may refer to a transport block (TB) that may be segmented into one or more code block(s), with each code block being the size (e.g., in number or quantity of bits) of the encoding/decoding block. The base graph may refer to a small graph that captures the macroscopic properties of the code (e.g., the threshold). The base graph may be referred to as the photograph of the code. The base graph may be represented by a matrix (e.g., a base matrix) whose columns denote the variable nodes and whose rows denote the check nodes of the base graph. A lifting process may include each of the entries in the base graph matrix being lifted by a circulant identity matrix. This may include copying the base graph Z times (where Z refers the number or quantity of copies of the base graphs) and then connecting the different copies of the base graph via edge permutation. The dimensions of the identity matrix may be Z*Z and circulant may be denoted by an integer in the non-zero entries of the base graph matrix. The LDPC code block length may correspond to the base graph multiplied by Z (e.g., the lift value). Scaling of the LDPC up and down (e.g., changing the code block size) may present an issue in a unified wireless network.

For example, the LDPC coding chip area may be primarily determined by two components. The first component is the memory used to store check and variable node LLRs. For a given code design, the memory may mostly be determined by the max Z value (e.g., the code block size). The second component is the decoding logical operations used to perform the actual decoding. In some aspects, the decoding throughput may be determined by the amount of decoding logical operations (e.g., how many bits can be decoded in the same clock cycle), which may be independent from the memory size. Accordingly, the LDCP coding (e.g., encoding or decoding) area may not scale proportionately with the throughput requirement. At a small scale (e.g., in the IoT regime) the memory may dominate the total area. At a very large throughput the number of processing units (e.g., parallel processing units) may dominate. When the throughput becomes even larger it may be more efficient to use more than one decoder.

Thus, in some aspects for different throughput rate targets the maximum code block size that achieves the highest area efficiency may be different. However, in some networks the code block size may be fixed for all devices (e.g., eMBB, RedCap, eRedCap, and other device types) and was designed mainly for eMBB. As a result, eRedCap implementation may become cost ineffective for the wireless networks.

Accordingly, aspects of the techniques described herein provide for coding design (e.g., for advanced networks, such as 6G networks and beyond) for the data channel to enable better co-design between different device types. In some aspects, this may be based on UE capability reporting where the UE 205 reports the maximum supported code block (e.g., Kₘₐₓ) (or the maximum lifting size, e.g., Z value for LDPC coding Zₘₐₓ) as a UE capability. For example, the UE 205 may transmit or otherwise output (and the network entity 210 may receive or otherwise obtain) a UE capability message that identifies a maximum code block size supported by the UE 205. The maximum code block size may correspond to a LDPC coding process of the UE 205 (e.g., either LDPC encoding or decoding operations of the UE 205). The UE 205 and the network entity 210 may perform wireless communications including code block(s) where the size of each code block in the code block(s) is based at least in part on the maximum code block size supported by the UE 205. As discussed above, the examples described herein generally include Uu interface-based cellular communications between the UE 205 and the network entity 210 but may be equally applicable to PC5 interface-based sidelink communications between the UE 205 and another UE.

In some aspects, the UE capability message may carry or otherwise convey an indication of the maximum code block size supported by the UE as a maximum quantity of bits supported in a code block (e.g., Kₘₐₓ) or a maximum lifting size supported for the LDCP coding process (e.g., Zₘₐₓ). That is, the UE capability message may carry or otherwise convey information identifying Kₘₐₓ or Zₘₐₓ to inform the network entity 210 of the maximum code block size supported by the UE 205. The maximum lifting size may be associated with the cyclic lifting process (e.g., copying) of the LDPC coding process. In a situation where multiple base graphs (e.g., of different base graph sizes) are supported for the LDPC coding process, the UE may report separate Zₘₐₓ values for different base graph sizes. In the situation where the Kₘₐₓ is reported by the UE 205, this may indicate that all Z values are such that ZK_{BG}<Kₘₐₓ are supported by the UE 205.

Additionally, or alternatively, there may be separate UE capability reporting indications for uplink and downlink communications (e.g., since the code block size affects uplink and downlink communications differently. For example, the uplink and the downlink communications may have different maximum data rate targets. Separate reporting may also be provided or otherwise indicted in the UE capability message for sidelink communications. Accordingly, in some aspects the maximum code block size identified in the UE capability message comprises at least one of a maximum uplink code block size, a maximum downlink code block size, and a maximum sidelink code block size.

In some aspects, there may be a common (e.g., maximum) code block size that all UEs within a wireless network may support. This code block size may be referred to as a reference code block size (e.g., K_{ref}) and Kₘₐₓ may be greater than or equal to K_{ref}. Accordingly, in some examples the UE 205 and the network entity 210 may perform additional wireless communications in accordance with the reference code block size (e.g., K_{ref}). For communications channels used prior to an RRC connection being established (e.g., such as remaining minimum system information (RMSI) physical downlink shared channel (PDSCH) message(s), system information block (SIB) message(s), other system information (OSI) message(s), physical random access channel (PRACH) message two (Msg2), message three (Msg3) or message four (Msg4) message(s) or paging channel messages, the maximum code block size used for these channels may be the reference code block size (e.g., K_{ref}). For broadcast or multicast channels, either Kₘₐₓ or K_{ref} may be used. For unicast communications in the RRC connected state, the maximum code block size may be determined based on configured RRC parameters.

As discussed above, two options may be used for reporting the maximum code block size supported by the UE 205 (e.g., Kₘₐₓ or Zₘₐₓ). Either reported value may be used to derive or otherwise determine the other value (e.g., Kₘₐₓ may be derived using Zₘₐₓ, and vice versa). In one example, Kₘₐₓ may be reported as 2112 (e.g., 96*22[K_{b}], which may indicate that Zₘₐₓ is equal to 96. K_{b} may refer to the size of the base graph, in this example. One option that may be used is for the UE 205 to report in the UE capability message that Kₘₐₓ is equal to α*K_{ref}, where α is equal to 1, 2, 4, 8, . . . . In this example, the α reported in the UE capability message may refer to a scaling factor applied to the reference code block size supported by all UE as a means for the UE 205 to indicate the maximum code block size it supports. In this example, α being equal to 8 may indicate that the maximum code block size is twice as large as the maximum code block size used in an NR wireless network. Alternatively, this may include the Kₘₐₓ not being reported as an integer multiple of K_{ref} (e.g., Kₘₐₓ=128*22). In this case, it may be more convenient and efficient for the UE to report Kₘₐₓ is equal to 128 (e.g., the corresponding Z_{ref} is equal to 96).

Whether the maximum or reference code block size are used for performing the wireless communications may be based on various considerations or factors. For example, the UE 205 may select or otherwise identify the maximum code block size or the reference code block size as the code block size to be used for each code block being conveyed in the wireless communications. As one example, the maximum code block size (or Zₘₐₓ) to be used for performing the wireless communications may be RRC configured by the network entity 210 based on the UE capability message. For example, the network entity 210 may transmit or otherwise output (and the UE 205 may receive or otherwise obtain) a configuration associated with a network-configured maximum code block size to be used for performing the wireless communications. The network-configured maximum code block size may be equal to or less than the maximum code block size indicted in the UE capability message. That is, the network entity 210 may configure the maximum code block size for the code block(s) being conveyed in the wireless communication in consideration of the maximum code block size supported by the UE 205.

In some aspects, the UE 205 may select the maximum code block size to be used for the wireless communications in accordance with a format of a downlink control information (DCI) grant scheduling the wireless communications. For example, a transmission scheduled by a fallback DCI may use K_{ref} as the maximum code block size whereas a transmission scheduled by a non-fallback DCI format may use Kₘₐₓ as the code block size, or vice versa. As another example, the UE 205 may select the maximum code block size to be used in accordance with a radio network temporary identifier (RNTI) associated with the DCI grant. For example, a cellular RNTI (C-RNTI), a configured scheduling RNTI (CS-RNTI), a paging RNTI (P-RNTI), a system information RNTI (SI-RNTI), a random access RNTI (RA-RNTI), a PRACH message B (MsgB) RNTI (MsgB-RNTI), or other RNTI used for the DCI grant scheduling the wireless communications may convey an indication of which maximum code block size is to be used to perform the wireless communications. As another example, the UE 205 may select the maximum code block size in accordance with a modulation and coding scheme (MCS) table associated with the DCI grant. For example, the MCS table to be used for the wireless communications (e.g., as indicated in the DCI grant or otherwise indicated) may indicate which maximum code block size is to be used to perform the wireless communications. As yet another example, the UE 205 may select the maximum code block size in accordance with a scheduling mode associated with the wireless communications. For example, a default mode may include wireless communications using downlink semi-persistent scheduling (SPS) resources or uplink configured grant (CG) resources may be Kₘₐₓ as the maximum code block size (e.g., since these are associated with being in the RRC connected state). In some aspects, the network entity 210 may configure whether a particular downlink SPS or uplink CG uses K_{ref} or Kₘₐₓ (e.g., in case the SPS or CG resources are used for broadcast or multicast applications).

In some aspects, the maximum code block size may be restricted to the reference code block size in accordance with a channel type associated with the wireless communications. The channel types in this example may include the RMSI PDSCH, SIB, OSI, msg 2, msg 3, msg4, paging channel, or other channel types discussed above. Accordingly, in some aspects for some common channel types the described techniques may restrict the maximum TB size to not exceed K_{ref}. That is, if the value of K_{ref} is selected properly, this approach may not limit the actual use. For example, in NR wireless networks the payload size range for different channels may be given as follows: Msg2: 72 bits, Msg3: 56 bits, Msg4: 1100 bits, and RMSI: 800-1500 bits. In some aspects, by definition K_{ref} may denote the reference code block size (instead of the TB size).

Some wireless networks may support probabilistic shaping operations as part of the coding and modulation techniques. Probabilistic shaping operations are generally performed on a per-code block basis. Accordingly, aspects of the techniques described herein may be applicable for such probabilistic shaping operations performed on a code block. For example, the maximum size of a probabilistic shaping block may be determined or otherwise selected from either Kₘₐₓ and K_{ref}. In the situation where the maximum probabilistic shaping block size is determined from K_{ref} and the actual code block size is greater than K_{ref}, this may mean that there are multiple shaping blocks within one LDPC code block. Accordingly, in some aspects the UE 205 may identify or otherwise select the code block size for the code block(s) according to a probabilistic shaping operation performed on the code block(s) based at least in part on the maximum code block size or the reference code block size.

Moreover, for channel quality feedback the UE 205 may generally assume the transmission parameters associated with a hypothetical PDSCH. Aspects of the techniques described herein may include the UE 205 may use an assumption on the code block size to compute the precoding matrix indicator (PMI), the channel quality indicator (CQI), or the rank indicator (RI) being reported to the network entity 210. The assumption used for the code block size may be either the maximum supported code block size supported by the UE 205 (e.g., Kₘₐₓ) or the reference code block size (e.g., K_{ref}). Accordingly, in some aspects the UE 205 may identify or otherwise determine one or more channel quality metrics (e.g., PMI, CQI, RI) for reporting in accordance with at least one of the maximum code block size supported by the UE 205 or the reference code block size.

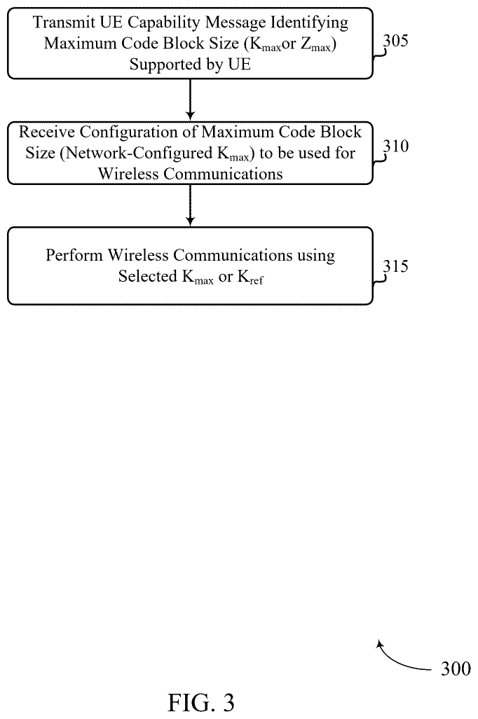

FIG. 3 shows an example of a method 300 that supports code block size reporting design in accordance with one or more aspects of the present disclosure. Aspects of method 300 may be implemented at or implemented by aspects of the wireless communications system 100 or the wireless communications system 200. Aspects of the method 300 may be implemented at or implemented by a UE or network entity, which may be examples of the corresponding devices described herein.

At 305, the UE may transmit or otherwise output (and the network entity may receive or otherwise obtain) a UE capability message that identifies a maximum code block size supported by the UE. The maximum code block size may correspond to a LDPC coding process of the UE. For example, the maximum code block size may be used during the LDPC coding process of the UE. In some aspects, the maximum code block size indicated in the UE capability message may be the maximum quantity of bits supported in a code block (e.g., Kₘₐₓ) or may be a maximum lifting size supported for the LDPC coding process (e.g., Zₘₐₓ). In the situation where different size base graphs are used in the LDPC coding process, the UE capability message may indicate separate Zₘₐₓ values for the different base graph sizes. In some examples, the UE capability message may indicate the maximum code block size as an offset value (e.g., α) that is used with a reference code block size to determine the maximum code block size.

At 310, the network entity may transmit or otherwise output (and the UE may receive or otherwise obtain) a configuration associated with a network-configured maximum code block size to be used for the wireless communications. The network-configured maximum code block size may be equal to or less than the maximum code block size supported by the UE as reported in the UE capability message. For example, the network entity may select the value for the maximum code block size to be used for the wireless communications to be no more than the maximum code block size supported by the UE.

At 315, the UE and the network entity may perform wireless communications that include conveying one or more code blocks. The size of each code block on the one or more code blocks may be based at least in part on the maximum code block size supported by the UE (e.g., according to the UE capability message reported by the UE). For example, the network entity may transmit a DCI grant to the UE that schedules the wireless communications. In some aspects, the DCI grant may be used to indicate or otherwise identify the network-configured maximum code block size to be used for the wireless communications. For example, the format of the DCI grant, the RNTI used for the DCI grant, an MCS table associated with the DCI grant, or a scheduling mode (e.g., SPS or CG resources or dynamically scheduled resources to be used for the wireless communications) may convey the indication of the network-configured maximum code block size.

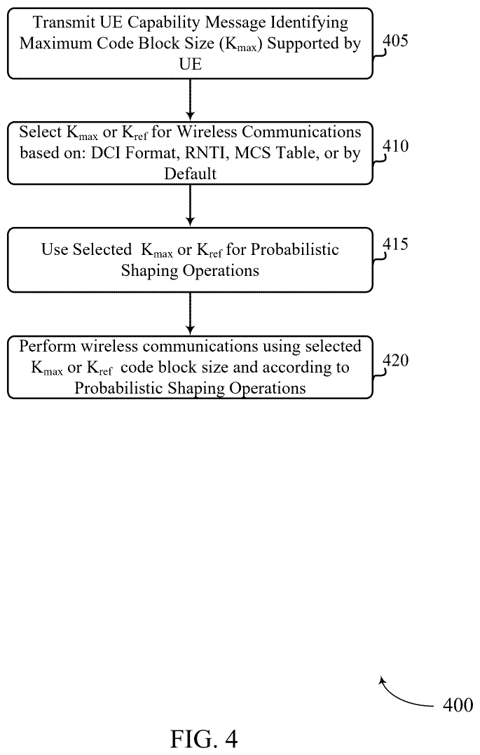

FIG. 4 shows an example of a method 400 that supports code block size reporting design in accordance with one or more aspects of the present disclosure. Aspects of method 400 may be implemented at or implemented by aspects of the wireless communications system 100 or the wireless communications system 200 or aspects of method 300. Aspects of the method 400 may be implemented at or implemented by a UE or network entity, which may be examples of the corresponding devices described herein.

At 405, the UE may transmit or otherwise output (and the network entity may receive or otherwise obtain) a UE capability message that identifies a maximum code block size supported by the UE. The maximum code block size may correspond to a LDPC coding process of the UE. For example, the maximum code block size may be used during the LDPC coding process of the UE. In some aspects, the maximum code block size indicated in the UE capability message may be the maximum quantity of bits supported in a code block (e.g., Kₘₐₓ) or may be a maximum lifting size supported for the LDPC coding process (e.g., Zₘₐₓ). In the situation where different size base graphs are used in the LDPC coding process, the UE capability message may indicate separate Zₘₐₓ values for the different base graph sizes. In some examples, the UE capability message may indicate the maximum code block size as an offset value (e.g., α) that is used with a reference code block size to determine the maximum code block size.

At 410, the UE may select or otherwise choose a maximum code block size or a reference code block size as the code block size used for each code block to be conveyed in the wireless communications. For example, the UE may select the maximum code block size reported in the UE capability message or the reference code block size to be used for the wireless communications in accordance with or otherwise based on at least one of a format of the DCI grant scheduling the wireless communications, the RNTI associated with the DCI grant, the MCS table associated with the DCI grant, and a scheduling mode (e.g., SPS/CG resources or dynamically scheduled resources) associated with the wireless communications.

At 415, the UE may perform probabilistic shaping operations according to or otherwise based on the selected code block size (e.g., either Kₘₐₓ or K_{ref}). For example, the UE may perform the probabilistic shaping operations on a per-code block size basis where the size (e.g., number or quantity of bits) of each code block is based on the selected code block size.

At 420, the UE and the network entity may perform wireless communications that include conveying one or more code blocks. The size of each code block on the one or more code blocks may be based at least in part on the selected code block size (e.g., either Kₘₐₓ or K_{ref}). The wireless communications may be performed according to the probabilistic shaping operations performed on each code block.

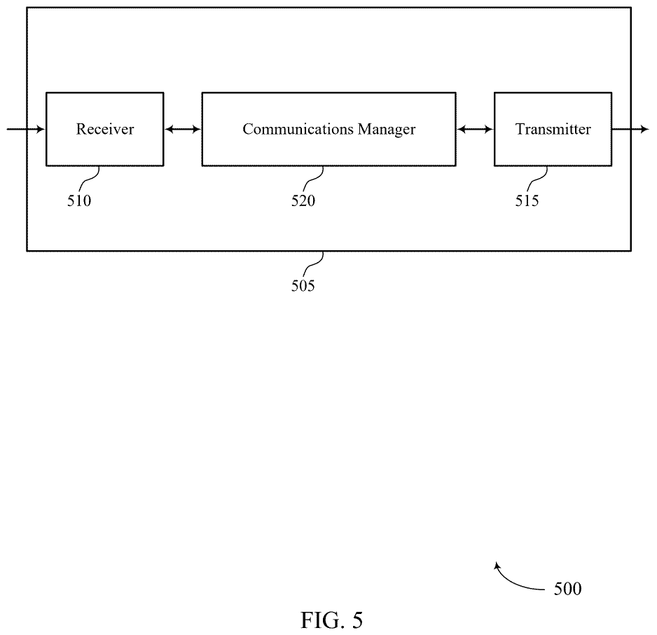

FIG. 5 shows a block diagram 500 of a device 505 that supports code block size reporting design in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to code block size reporting design). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to code block size reporting design). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of code block size reporting design as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a UE capability message that identifies a maximum code block size supported by the UE, where the maximum code block size corresponds to a LDPC coding process of the UE. The communications manager 520 is capable of, configured to, or operable to support a means for performing wireless communications including one or more code blocks, where a code block size of each code block in the one or more code blocks is based on the maximum code block size supported by the UE.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for scaling coding operations at a UE to improved co-design between different device types based on UE capability reporting.

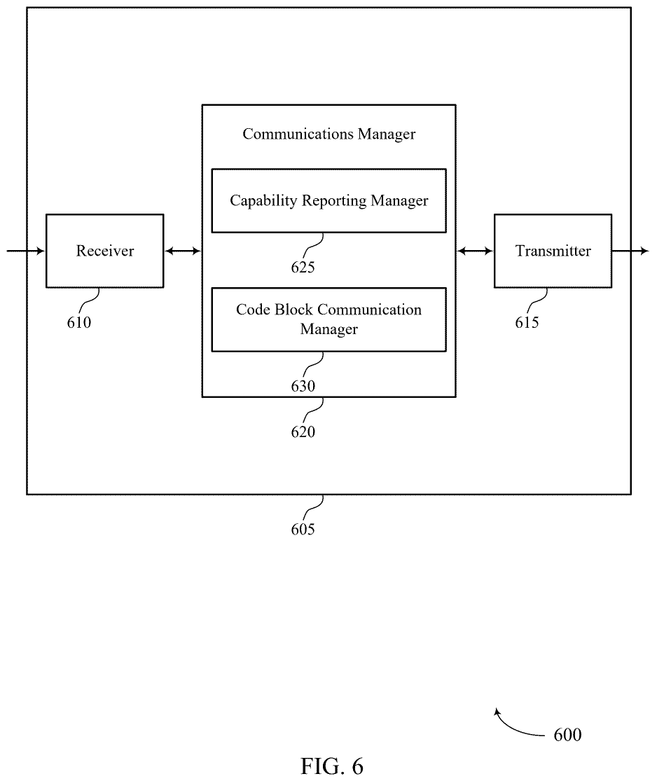

FIG. 6 shows a block diagram 600 of a device 605 that supports code block size reporting design in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to code block size reporting design). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to code block size reporting design). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of code block size reporting design as described herein. For example, the communications manager 620 may include a capability reporting manager 625 a code block communication manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The capability reporting manager 625 is capable of, configured to, or operable to support a means for transmitting a UE capability message that identifies a maximum code block size supported by the UE, where the maximum code block size corresponds to a LDPC coding process of the UE. The code block communication manager 630 is capable of, configured to, or operable to support a means for performing wireless communications including one or more code blocks, where a code block size of each code block in the one or more code blocks is based on the maximum code block size supported by the UE.

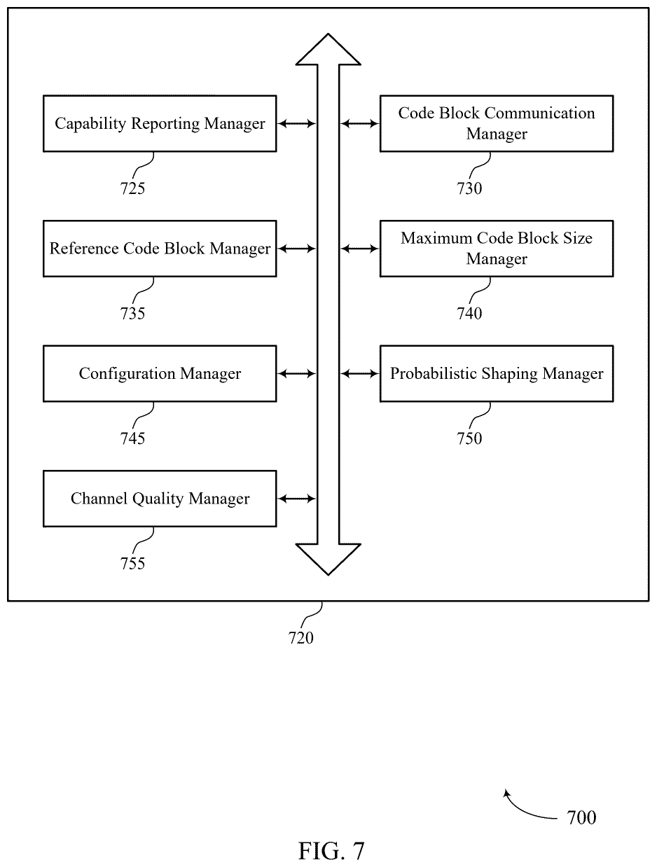

FIG. 7 shows a block diagram 700 of a communications manager 720 that supports code block size reporting design in accordance with one or more aspects of the present disclosure. The communications manager 720 may be an example of aspects of a communications manager 520, a communications manager 620, or both, as described herein. The communications manager 720, or various components thereof, may be an example of means for performing various aspects of code block size reporting design as described herein. For example, the communications manager 720 may include a capability reporting manager 725, a code block communication manager 730, a reference code block manager 735, a maximum code block size manager 740, a configuration manager 745, a probabilistic shaping manager 750, a channel quality manager 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The capability reporting manager 725 is capable of, configured to, or operable to support a means for transmitting a UE capability message that identifies a maximum code block size supported by the UE, where the maximum code block size corresponds to a LDPC coding process of the UE. The code block communication manager 730 is capable of, configured to, or operable to support a means for performing wireless communications including one or more code blocks, where a code block size of each code block in the one or more code blocks is based on the maximum code block size supported by the UE.

In some examples, the UE capability message indicates the maximum code block size supported by the UE as at least one of a maximum quantity of bits supported in a code block or a maximum lifting size supported for the LDPC coding process. In some examples, the maximum lifting size is associated with a cyclic lifting process of the LDPC coding process. In some examples, the maximum code block size identified in the UE capability message includes at least one of a maximum uplink code block size, a maximum downlink code block size, and a maximum sidelink code block size.

In some examples, the reference code block manager 735 is capable of, configured to, or operable to support a means for performing additional wireless communications in accordance with a reference code block size, where the reference code block size satisfies at least the maximum code block size supported by the UE.

In some examples, the maximum code block size manager 740 is capable of, configured to, or operable to support a means for selecting, for the wireless communications, the maximum code block size or a reference code block size as the code block size used for each code block in the one or more code blocks. In some examples, the selecting is in accordance with at least one of a format of a DCI grant scheduling the wireless communications, a RNTI associated with the DCI grant, a MCS table associated with the DCI grant, and a scheduling mode associated with the wireless communications.

In some examples, the configuration manager 745 is capable of, configured to, or operable to support a means for receiving a configuration associated with a network-configured maximum code block size to be used for the wireless communications, where the network-configured maximum code block size is equal to or less than the maximum code block size identified in the UE capability message. In some examples, the maximum code block size is restricted to a reference code block size in accordance with a channel type associated with the wireless communications.

In some examples, the probabilistic shaping manager 750 is capable of, configured to, or operable to support a means for selecting the code block size for the one or more code blocks according to a probabilistic shaping operation performed on the one or more code blocks based on the maximum code block size or a reference code block size.

In some examples, the channel quality manager 755 is capable of, configured to, or operable to support a means for determining one or more channel quality metrics for reporting in accordance with at least one of the maximum code block size or a reference code block size.

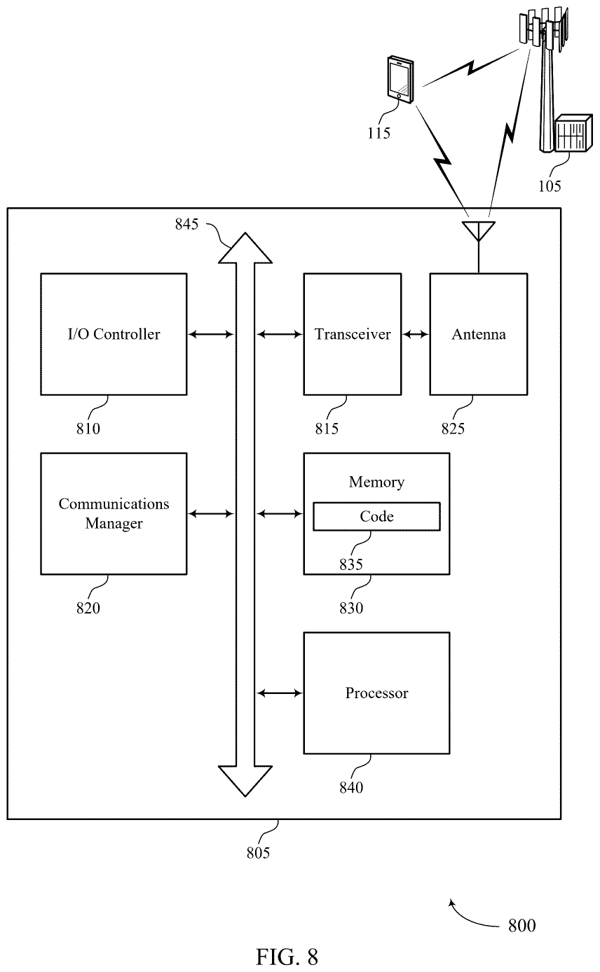

FIG. 8 shows a diagram of a system 800 including a device 805 that supports code block size reporting design in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting code block size reporting design). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a UE capability message that identifies a maximum code block size supported by the UE, where the maximum code block size corresponds to a low-density parity-check (LDPC) coding process of the UE. The communications manager 820 is capable of, configured to, or operable to support a means for performing wireless communications including one or more code blocks, where a code block size of each code block in the one or more code blocks is based on the maximum code block size supported by the UE.

By including or configuring the communications manager 820 in accordance with examples as described herein, the device 805 may support techniques for scaling coding operations at a UE to improved co-design between different device types based on UE capability reporting.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of code block size reporting design as described herein, or the at least one processor 840 and the at least one memory 830 may be otherwise configured to, individually or collectively, perform or support such operations.

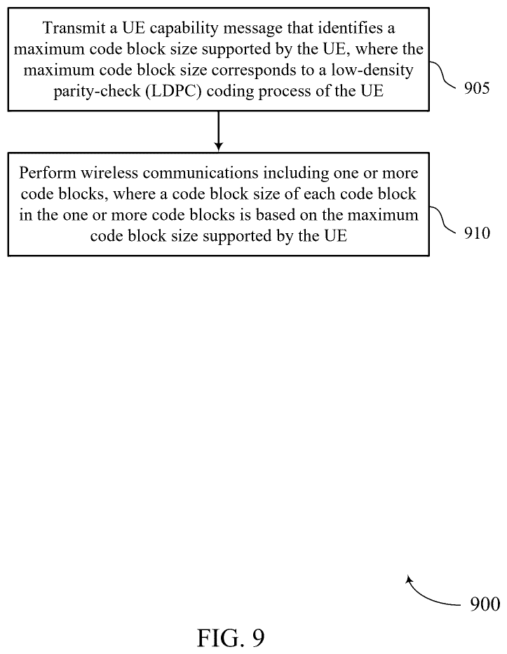

FIG. 9 shows a flowchart illustrating a method 900 that supports code block size reporting design in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting a UE capability message that identifies a maximum code block size supported by the UE, where the maximum code block size corresponds to a LDPC coding process of the UE. The operations of 905 may be performed in accordance with examples as disclosed herein. In some examples, aspects of the operations of 905 may be performed by a capability reporting manager 725 as described with reference to FIG. 7.

At 910, the method may include performing wireless communications including one or more code blocks, where a code block size of each code block in the one or more code blocks is based on the maximum code block size supported by the UE. The operations of 910 may be performed in accordance with examples as disclosed herein. In some examples, aspects of the operations of 910 may be performed by a code block communication manager 730 as described with reference to FIG. 7.

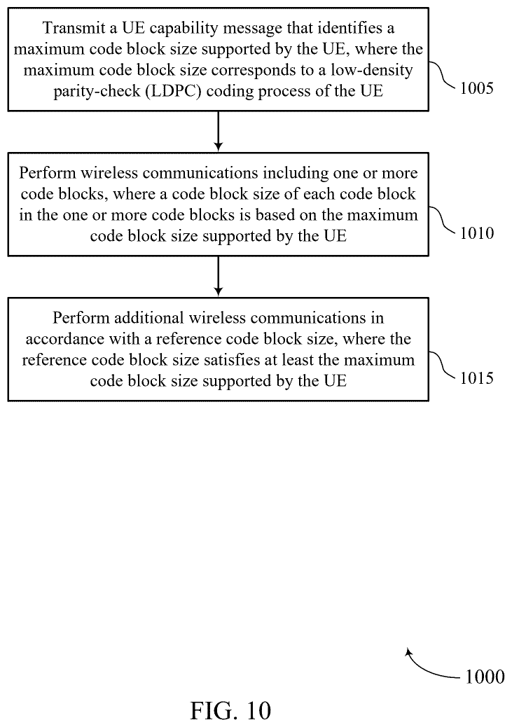

FIG. 10 shows a flowchart illustrating a method 1000 that supports code block size reporting design in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting a UE capability message that identifies a maximum code block size supported by the UE, where the maximum code block size corresponds to a LDPC coding process of the UE. The operations of 1005 may be performed in accordance with examples as disclosed herein. In some examples, aspects of the operations of 1005 may be performed by a capability reporting manager 725 as described with reference to FIG. 7.

At 1010, the method may include performing wireless communications including one or more code blocks, where a code block size of each code block in the one or more code blocks is based on the maximum code block size supported by the UE. The operations of 1010 may be performed in accordance with examples as disclosed herein. In some examples, aspects of the operations of 1010 may be performed by a code block communication manager 730 as described with reference to FIG. 7.

At 1015, the method may include performing additional wireless communications in accordance with a reference code block size, where the reference code block size satisfies at least the maximum code block size supported by the UE. The operations of 1015 may be performed in accordance with examples as disclosed herein. In some examples, aspects of the operations of 1015 may be performed by a reference code block manager 735 as described with reference to FIG. 7.

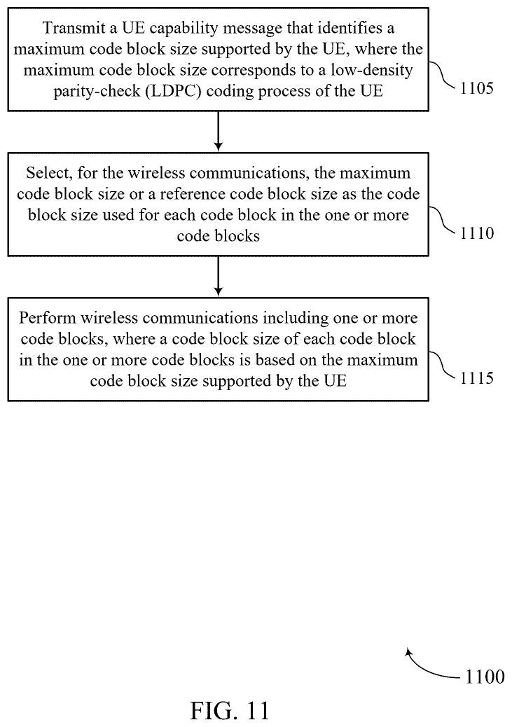

FIG. 11 shows a flowchart illustrating a method 1100 that supports code block size reporting design in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include transmitting a UE capability message that identifies a maximum code block size supported by the UE, where the maximum code block size corresponds to a LDPC coding process of the UE. The operations of 1105 may be performed in accordance with examples as disclosed herein. In some examples, aspects of the operations of 1105 may be performed by a capability reporting manager 725 as described with reference to FIG. 7.

At 1110, the method may include selecting, for the wireless communications, the maximum code block size or a reference code block size as the code block size used for each code block in the one or more code blocks. The operations of 1110 may be performed in accordance with examples as disclosed herein. In some examples, aspects of the operations of 1110 may be performed by a maximum code block size manager 740 as described with reference to FIG. 7.

At 1115, the method may include performing wireless communications including one or more code blocks, where a code block size of each code block in the one or more code blocks is based on the maximum code block size supported by the UE. The operations of 1115 may be performed in accordance with examples as disclosed herein. In some examples, aspects of the operations of 1115 may be performed by a code block communication manager 730 as described with reference to FIG. 7.

The following provides an overview of aspects of the present disclosure:

Aspect 1: A method for wireless communications at a UE, comprising: transmitting a UE capability message that identifies a maximum code block size supported by the UE, wherein the maximum code block size corresponds to a LDPC coding process of the UE; and performing wireless communications comprising one or more code blocks, wherein a code block size of each code block in the one or more code blocks is based at least in part on the maximum code block size supported by the UE.

Aspect 2: The method of aspect 1, wherein the UE capability message indicates the maximum code block size supported by the UE as at least one of a maximum quantity of bits supported in a code block or a maximum lifting size supported for the LDPC coding process.

Aspect 3: The method of aspect 2, wherein the maximum lifting size is associated with a cyclic lifting process of the LDPC coding process.

Aspect 4: The method of any of aspects 1 through 3, wherein the maximum code block size identified in the UE capability message comprises at least one of a maximum uplink code block size, a maximum downlink code block size, and a maximum sidelink code block size.

Aspect 5: The method of any of aspects 1 through 4, further comprising: performing additional wireless communications in accordance with a reference code block size, wherein the reference code block size satisfies at least the maximum code block size supported by the UE.

Aspect 6: The method of any of aspects 1 through 5, further comprising: selecting, for the wireless communications, the maximum code block size or a reference code block size as the code block size used for each code block in the one or more code blocks.

Aspect 7: The method of aspect 6, wherein the selecting is in accordance with at least one of a format of a DCI grant scheduling the wireless communications, a RNTI associated with the DCI grant, a MCS table associated with the DCI grant, and a scheduling mode associated with the wireless communications.

Aspect 8: The method of any of aspects 1 through 7, further comprising: receiving a configuration associated with a network-configured maximum code block size to be used for the wireless communications, wherein the network-configured maximum code block size is equal to or less than the maximum code block size identified in the UE capability message.

Aspect 9: The method of any of aspects 1 through 8, wherein the maximum code block size is restricted to a reference code block size in accordance with a channel type associated with the wireless communications.

Aspect 10: The method of any of aspects 1 through 9, further comprising: selecting the code block size for the one or more code blocks according to a probabilistic shaping operation performed on the one or more code blocks based at least in part on the maximum code block size or a reference code block size.

Aspect 11: The method of any of aspects 1 through 10, further comprising: determining one or more channel quality metrics for reporting in accordance with at least one of the maximum code block size or a reference code block size.

Aspect 12: A UE for wireless communications, comprising one or more memories storing processor-executable code, and one or more processors coupled with the one or more memories and individually or collectively operable to execute the code to cause the UE to perform a method of any of aspects 1 through 11.

Aspect 13: A UE for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a UE capability message that identifies a maximum code block size supported by the UE, wherein the maximum code block size corresponds to a low-density parity-check (LDPC) coding process of the UE; and
perform wireless communications comprising one or more code blocks, wherein a code block size of each code block in the one or more code blocks is based at least in part on the maximum code block size supported by the UE.

2. The UE of claim 1, wherein the UE capability message indicates the maximum code block size supported by the UE as at least one of a maximum quantity of bits supported in a code block or a maximum lifting size supported for the LDPC coding process.

3. The UE of claim 2, wherein the maximum lifting size is associated with a cyclic lifting process of the LDPC coding process.

4. The UE of claim 1, wherein the maximum code block size identified in the UE capability message comprises at least one of a maximum uplink code block size, a maximum downlink code block size, and a maximum sidelink code block size.

5. The UE of claim 1, wherein the one or more processors are individually or collectively further operable to execute the code to cause the UE to:
perform additional wireless communications in accordance with a reference code block size, wherein the reference code block size satisfies at least the maximum code block size supported by the UE.

6. The UE of claim 1, wherein the one or more processors are individually or collectively further operable to execute the code to cause the UE to:
select, for the wireless communications, the maximum code block size or a reference code block size as the code block size used for each code block in the one or more code blocks.

7. The UE of claim 6, wherein the selecting is in accordance with at least one of a format of a downlink control information (DCI) grant scheduling the wireless communications, a radio network temporary identifier (RNTI) associated with the DCI grant, a modulation and coding scheme (MCS) table associated with the DCI grant, and a scheduling mode associated with the wireless communications.

8. The UE of claim 1, wherein the one or more processors are individually or collectively further operable to execute the code to cause the UE to:
receive a configuration associated with a network-configured maximum code block size to be used for the wireless communications, wherein the network-configured maximum code block size is equal to or less than the maximum code block size identified in the UE capability message.

9. The UE of claim 1, wherein the maximum code block size is restricted to a reference code block size in accordance with a channel type associated with the wireless communications.

10. The UE of claim 1, wherein the one or more processors are individually or collectively further operable to execute the code to cause the UE to:
select the code block size for the one or more code blocks according to a probabilistic shaping operation performed on the one or more code blocks based at least in part on the maximum code block size or a reference code block size.

11. The UE of claim 1, wherein the one or more processors are individually or collectively further operable to execute the code to cause the UE to:
determine one or more channel quality metrics for reporting in accordance with at least one of the maximum code block size or a reference code block size.

12. A method for wireless communications at a user equipment (UE), comprising:
transmitting a UE capability message that identifies a maximum code block size supported by the UE, wherein the maximum code block size corresponds to a low-density parity-check (LDPC) coding process of the UE; and
performing wireless communications comprising one or more code blocks, wherein a code block size of each code block in the one or more code blocks is based at least in part on the maximum code block size supported by the UE.

13. The method of claim 12, wherein the UE capability message indicates the maximum code block size supported by the UE as at least one of a maximum quantity of bits supported in a code block or a maximum lifting size supported for the LDPC coding process.

14. The method of claim 13, wherein the maximum lifting size is associated with a cyclic lifting process of the LDPC coding process.

15. The method of claim 12, wherein the maximum code block size identified in the UE capability message comprises at least one of a maximum uplink code block size, a maximum downlink code block size, and a maximum sidelink code block size.

16. The method of claim 12, further comprising:
performing additional wireless communications in accordance with a reference code block size, wherein the reference code block size satisfies at least the maximum code block size supported by the UE.

17. The method of claim 12, further comprising:
selecting, for the wireless communications, the maximum code block size or a reference code block size as the code block size used for each code block in the one or more code blocks.

18. The method of claim 17, wherein the selecting is in accordance with at least one of a format of a downlink control information (DCI) grant scheduling the wireless communications, a radio network temporary identifier (RNTI) associated with the DCI grant, a modulation and coding scheme (MCS) table associated with the DCI grant, and a scheduling mode associated with the wireless communications.

19. The method of claim 12, further comprising:
receiving a configuration associated with a network-configured maximum code block size to be used for the wireless communications, wherein the network-configured maximum code block size is equal to or less than the maximum code block size identified in the UE capability message.

20. A non-transitory computer-readable medium storing code for wireless communications, the code comprising instructions executable by one or more processors to:
transmit a UE capability message that identifies a maximum code block size supported by the UE, wherein the maximum code block size corresponds to a low-density parity-check (LDPC) coding process of the UE; and
perform wireless communications comprising one or more code blocks, wherein a code block size of each code block in the one or more code blocks is based at least in part on the maximum code block size supported by the UE.
